(19) United States
(12) Patent Application Publication
(10) Pub. No.: US 2009/0168119 A1
(43) Pub. Date: Jul. 2, 2009

(54) IMAGE SCANNING APPARATUS HAVING SCAN BACKGROUND AND IMAGE SCANNING METHOD THEREOF

(76) Inventors: Hsing-Lu Chen, Hsinchu City (TW); Yueh-Chang Wu, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 12/276,401

(22) Filed: Nov. 23, 2008

(30) Foreign Application Priority Data
Dec. 27, 2007 (TW) 096150614

(51) Int. Cl. H04N 1/04

(52) U.S. Cl. 358/474

(57) ABSTRACT

An image scanning apparatus having scan background includes an analog front end (AFE) processor, a logic circuit module, and a control module. The AFE processor is utilized for outputting an actual gray level value corresponding to a gray level value of a scan image of a scan target and the scan background. The logic circuit module is coupled to the AFE processor and utilized for comparing the actual gray level value with a reference gray level value and outputting a corresponding control signal. The control module is coupled to the logic circuit module and utilized for determining whether to stop a scanning operation according to the control signal.

### BACKGROUND OF THE INVENTION

1. Field of the Invention

The present invention relates to an image scanning apparatus and an image scanning method, and more particularly, to an image scanning apparatus having scan background and an image scanning method that are able to detect and recognize size of a scan target during the scanning process without using sensors.

2. Description of the Prior Art

In general, in order to detect the size of a scan target (such as a document or a picture) and determine a scanning area, the conventional scanners usually are equipped with a plurality of sensors for detection of the sizes of the documents being scanned, or a CPU of higher capability for processing the scan image in a post-processing procedure to generate the desired image. However, by employing such devices, the production costs and prices of the scanners would rise and consequently such scanners will lose its competitiveness.

### SUMMARY OF THE INVENTION

It is therefore one of the objectives of the present invention to provide an image scanning apparatus and image scanning method that are able to detect and recognize the size of a scan target during the scanning process by comparing a gray level value of the scan target image and the scan background image with a reference gray level value, and to solve the above problems.

According to an embodiment of the present invention, an image scanning apparatus having scan background is disclosed. The image scanning apparatus includes an analog front end (AFE) processor, a logic circuit module, and a control module. The AFE processor is utilized for outputting an actual gray level value corresponding to a gray level value of a scan image of a scan target and the scan background. The logic circuit module is coupled to the AFE processor, and utilized for comparing the actual gray level value with a reference gray level value and outputting a corresponding control signal. The control module is coupled to the logic circuit module, and utilized for determining whether to stop a scanning operation according to the control signal.

An image scanning method according to the embodiment of the present invention is disclosed. The image scanning method includes: setting a reference gray level value; outputting an actual gray level value corresponding to a gray level value of a scan image of a scan target and scan background; comparing the actual gray level value with the reference gray level value so as to output a control signal; and determining whether to stop a scanning operation according to the control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of an image scanning apparatus in accordance with a preferred embodiment of the present invention.

FIG. 2 shows a function table for the D-type flip-flop.

FIG. 3 shows a logic value variation state diagram for the D-type flip-flop in accordance with a first embodiment of the present invention.

FIG. 4 shows another logic value variation state diagram for the D-type flip-flop in accordance with the first embodiment.

FIG. 5 is a flowchart showing the image scanning method in accordance with the first embodiment.

FIG. 6 is another flowchart showing the image scanning method in accordance with the first embodiment.

FIG. 7 shows a logic value variation state diagram for the D-type flip-flop in accordance with a second embodiment of the present invention.

FIG. 8 shows another logic value variation state diagram for the D-type flip-flop in accordance with the second embodiment.

FIG. 9 is a flowchart showing the image scanning method in accordance with the second embodiment.

FIG. 10 is another flowchart showing the image scanning method in accordance with the second embodiment.

### DETAILED DESCRIPTION

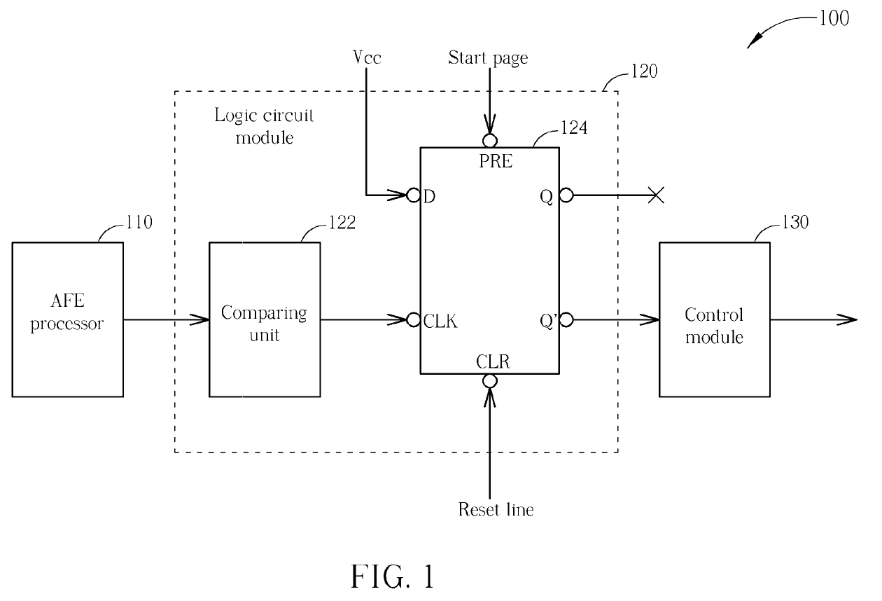

Please refer to FIG. 1. FIG. 1 shows a simplified block diagram of an image scanning apparatus 100 in accordance with a preferred embodiment of the present invention. As shown in FIG. 1, the image scanning apparatus 100 includes an analog front end (AFE) processor 110, a logic circuit module 120, and a control module 130. The logic circuit module 120 is coupled to the AFE processor 110, and the control module 130 is coupled to the logic circuit module 120. At first, for the detection of a scan background of the image scanning apparatus 100, a reference gray level value, selected from 0 to 255, is set as a threshold value. When the image scanning apparatus 100 performs a scanning operation, the AFE processor 110 outputs an actual gray level value corresponding to a scan target image (such as a document or a picture) and the scan background image. Thus, the logic circuit module 120 compares the actual gray level value with the reference gray level value to output a control signal, and the control module 130 determines whether to stop a scanning operation according to the control signal.

In the case that a white or light-colored scan background, the gray level value of which is higher, is used, a higher reference gray level value may be set, for example, 200. For any actual gray level value lower than 200, the control module will determine that the scan target is still being scanned and continues the scanning operation. For any actual gray level value higher than 200, the control module 130 determines that the scan background has been scanned and stops the scanning operation.

However, in the case that a black or dark-colored scan background, the gray level value of which is higher, is used, a lower reference gray level value may be set, for example, 20. For any actual gray level value higher than 20, the control module will determine that the scan target is still being scanned and continues the scanning operation. For any actual gray level value lower than 20, the control module 130 determines that the scan background has been scanned and stops the scanning operation.

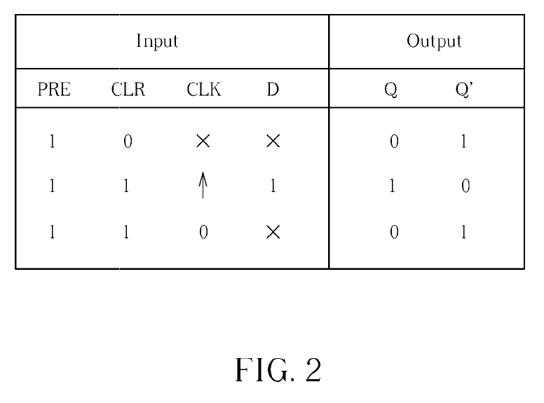

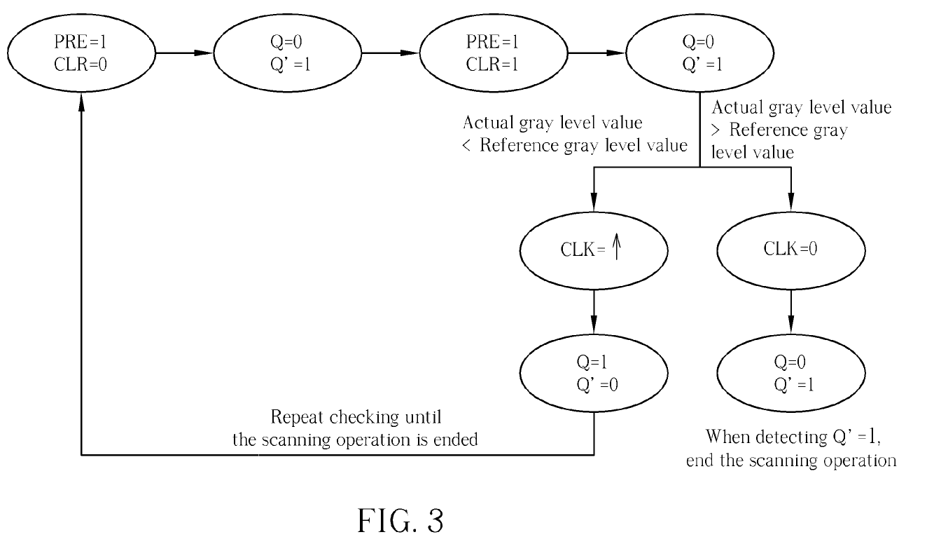

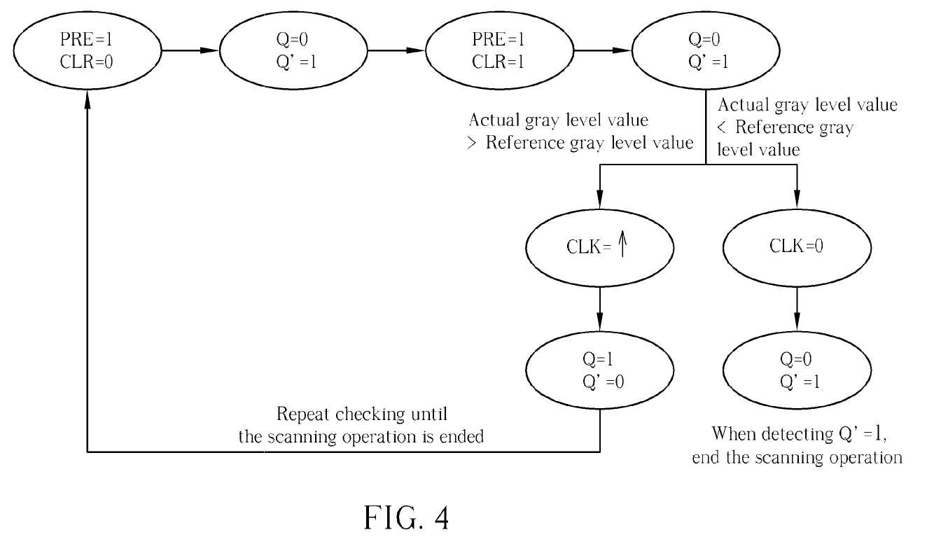

The logic circuit module 120 further comprises a comparing unit 122 and a flip-flop 124. The comparing unit 122 compares the actual gray level value with a reference gray level value to generate a comparing result. The flip-flop 124 may be a D-type flip-flop, and the D-type flip-flop 124 comprises a clock terminal CLK, a data input terminal D, a first data output terminal Q, a second data output terminal Q′, a preset terminal PRE, and a clear terminal CLR. The clock terminal CLK is coupled to the comparing unit 122 to receive the comparing result. The second data output terminal Q′ is coupled to the control module 130 to output the control signal. A logic value for the first data output terminal Q and the second data output terminal Q′ of the flip-flop 124 is according to a trigger of the clock terminal CLK and an input logic value (such as 1) for the data input terminal D of the flip-flop 124 is set. In addition, the control module 130 executes a firmware for constantly polling the second data output terminal Q′ to read the control signal at predetermined time interval which can be adjusted arbitrarily (for example, in accordance with the time for the image scanning apparatus 100 scanning a specific number of scan lines or a specific number of seconds). The preset terminal PRE and the clear terminal CLR in the D-type flip-flop 124 are utilized for directly setting a first initial logic value (such as 0) to the first data output terminal Q, and directly setting a second initial logic value (such as 1) to the second data output terminal Q′. Please refer to FIG. 2, FIG. 3 and FIG. 4. FIG. 2 shows a function table for the D-type flip-flop 124. FIG. 3 shows a logic value variation state diagram of the D-type flip-flop 124 when white or light scan background is used. FIG. 4 shows a logic value variation state diagram of the D-type flip-flop 124 when black or dark scan background is used in accordance with the first embodiment of the present invention. Please note that the D-type flip-flop in the first embodiment of the present invention can be replaced by other types of logic circuits to attain the same purpose after reading the above description.

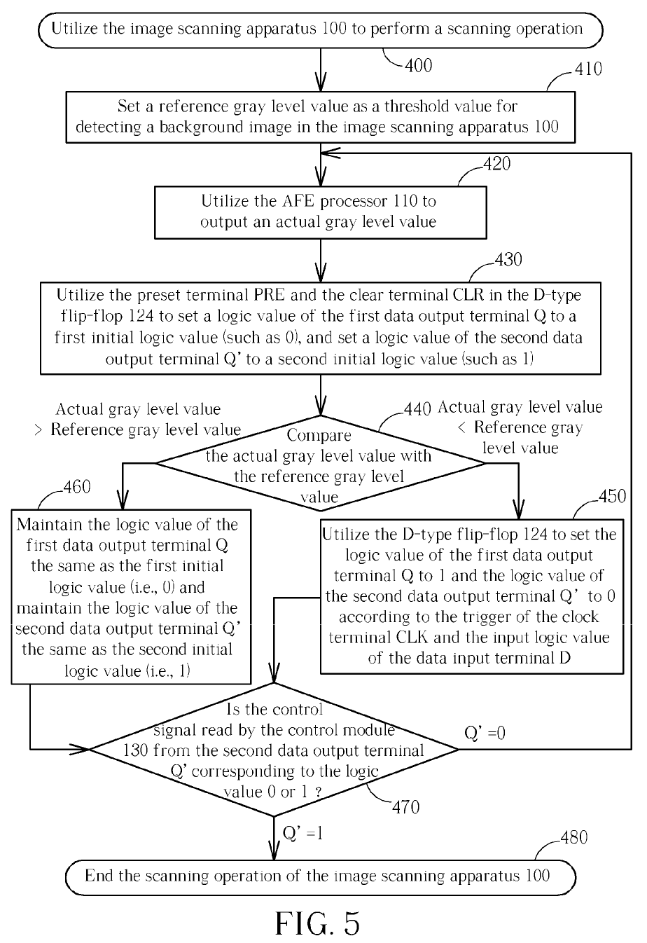

Please refer to FIG. 5. FIG. 5 is a flowchart showing the image scanning method of the first embodiment when white or light scan background is used according to the present invention. The method includes the following steps:

Step 400: Utilize the image scanning apparatus 100 to perform a scanning operation.

Step 410: Set a reference gray level value as a threshold value for detecting a background image in the image scanning apparatus 100.

Step 420: Utilize the AFE processor 110 to output an actual gray level value.

Step 430: Utilize the preset terminal PRE and the clear terminal CLR in the D-type flip-flop 124 to set a logic value of the first data output terminal Q to a first initial logic value (such as 0), and set a logic value of the second data output terminal Q′ to a second initial logic value (such as 1).

Step 440: Utilize the comparing unit 122 to compare the actual gray level value with a reference gray level value to generate a comparing result. When the actual gray level value is lower than the reference gray level value, utilize the corresponding comparing result to trigger the clock terminal CLK of the D-type flip-flop 124, and then go to Step 450; when the actual gray level value is higher than the reference gray level value, go to Step 460.

Step 450: Utilize the D-type flip-flop 124 to set the logic value of the first data output terminal Q to 1 and the logic value of the second data output terminal Q′ to 0 according to the trigger of the clock terminal CLK and the input logic value of the data input terminal D, and then go to Step 470.

Step 460: Maintain the logic value of the first data output terminal Q the same as the first initial logic value (i.e., 0) and maintain the logic value of the second data output terminal Q′ the same as the second initial logic value (i.e., 1), and then go to Step 470.

Step 470: Utilize the control module 130 to execute a firmware for constantly polling the second data output terminal Q′ to read the control signal at a predetermined time interval. When the control signal from the second data output terminal Q′ corresponds to the logic value 0, go to Step 420, and when the control signal from the second data output terminal Q′ corresponds to the logic value 1, go to Step 480.

Step 480: End the scanning operation of the image scanning apparatus 100.

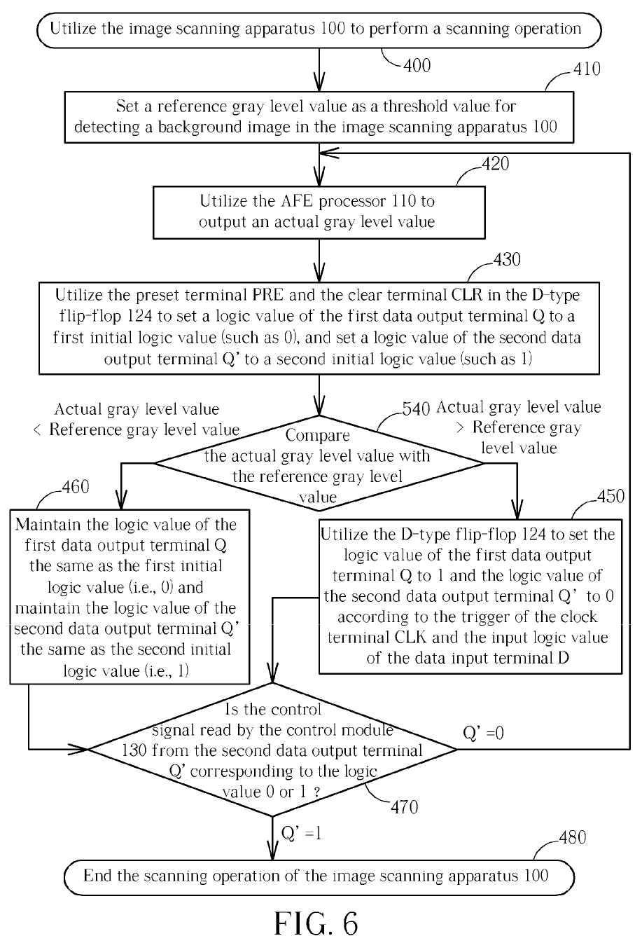

Please refer to FIG. 6. FIG. 6 is another flowchart showing the image scanning method of the first embodiment when black or dark scan background is used. The method includes the same steps as Steps 400 to 480 set forth above, except that Step 440 is replaced with a Step 540 described below:

Step 540: Utilize the comparing unit 122 to compare the actual gray level value with a reference gray level value to generate a comparing result. When the actual gray level value is higher than the reference gray level value, utilize the corresponding comparing result to trigger the clock terminal CLK of the D-type flip-flop 124, and then go to Step 450; when the actual gray level value is lower than the reference gray level value, go to Step 460.

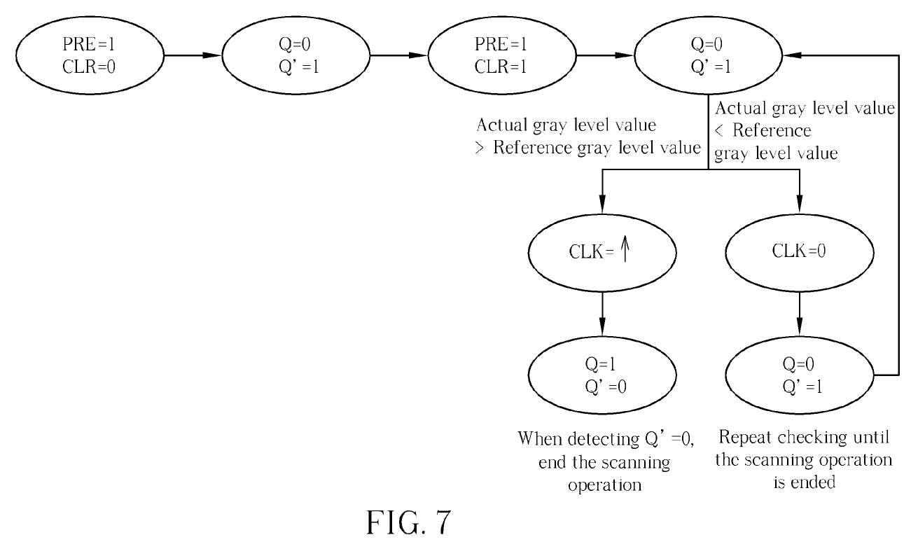

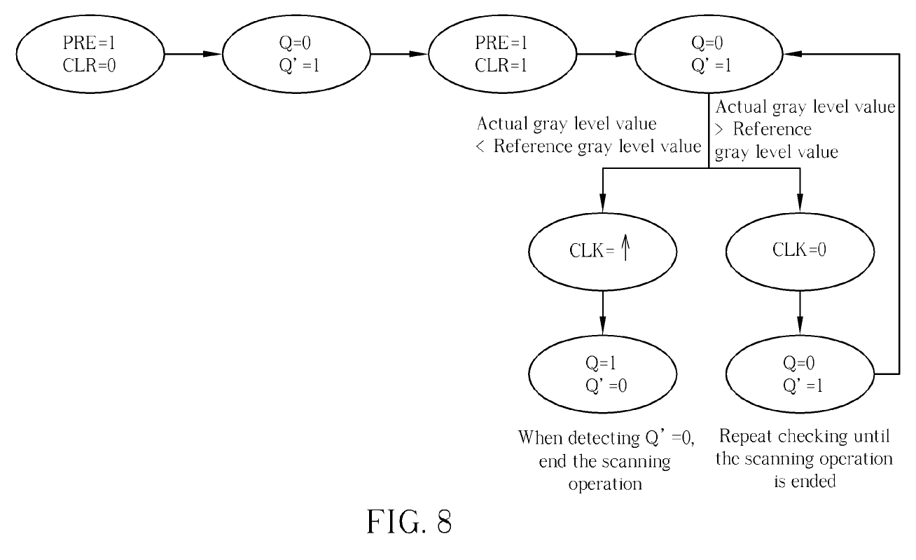

An image scanning method according to a second embodiment of the present invention is similar to the image scanning method according to the first embodiment of the present invention. The difference is that the clock terminal CLK of the D-type flip-flop 124 is triggered when the scan background is scanned. Please refer to FIG. 2, FIG. 7, and FIG. 8 together. FIG. 7 shows a logic value variation state diagram of the D-type flip-flop 124 at different stages when white or light scan background is used and the operation scheme of the image scanning apparatus 100 in the second embodiment. FIG. 8 shows another logic value variation state diagram of the D-type flip-flop at different stages when black or dark scan background is used and the operation scheme of the image scanning apparatus 100 in the second embodiment.

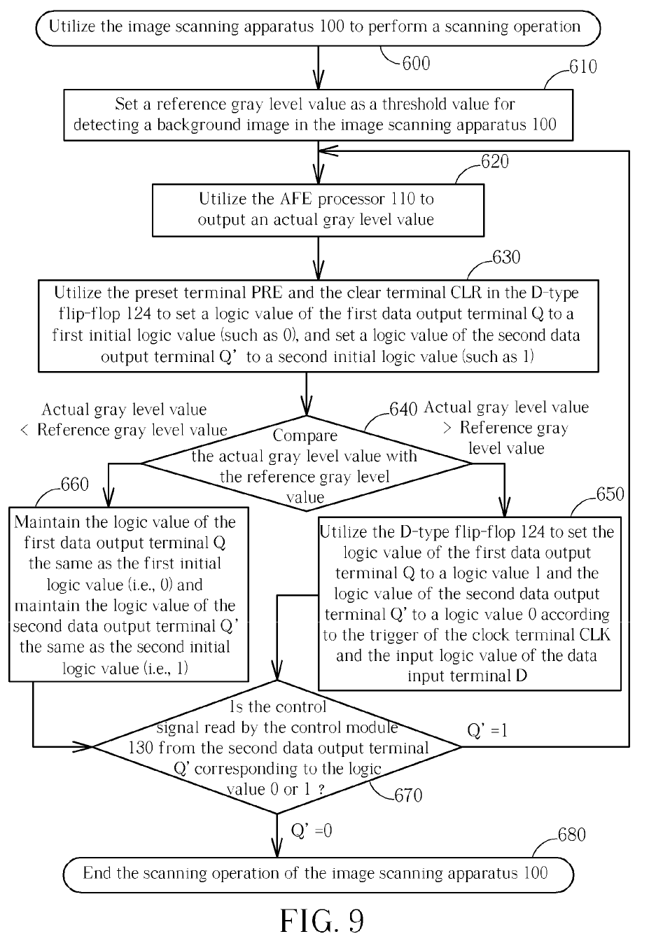

Please refer to FIG. 9. FIG. 9 is a flowchart showing a image scanning method of the second embodiment when white or light scan background is used. The image scanning method includes the following steps:

Step 600: Utilize the image scanning apparatus 100 to perform a scanning operation.

Step 610: Set a reference gray level value as a threshold value for detecting a background image in the image scanning apparatus 100.

Step 620: Utilize the AFE processor 110 to output an actual gray level value.

Step 630: Utilize the preset terminal PRE and the clear terminal CLR in the D-type flip-flop 124 to set a logic value of the first data output terminal Q to a first initial logic value (such as 0), and set a logic value of the second data output terminal Q′ to a second initial logic value (such as 1).

Step 640: Utilize the comparing unit 122 to compare the actual gray level value with a reference gray level value to generate a comparing result. When the actual gray level value is higher than the reference gray level value, utilize the corresponding comparing result to trigger the clock terminal CLK of the D-type flip-flop 124, and then go to Step 650; when the actual gray level value is lower than the reference gray level value, go to Step 660.

Step 650: Utilize the D-type flip-flop 124 to set the logic value of the first data output terminal Q to a logic value 1 and the logic value of the second data output terminal Q′ to a logic value 0 according to the trigger of the clock terminal CLK and the input logic value of the data input terminal D, and then go to Step 670.

Step 660: Maintain the logic value of the first data output terminal Q the same as the first initial logic value (i.e., 0) and maintain the logic value of the second data output terminal Q′ the same as the second initial logic value (i.e., 1), and then go to Step 670.

Step 670: Utilize the control module 130 to execute a firmware for constantly polling the second data output terminal Q′ to read the control signal at a predetermined time interval which can be adjusted arbitrarily. When the control signal read by the control module 130 corresponds to the logic value 1, go to Step 620, and when the control signal read by the control module 130 corresponds to the logic value 0, go to Step 680.

Step 680: End the scanning operation of the image scanning apparatus 100.

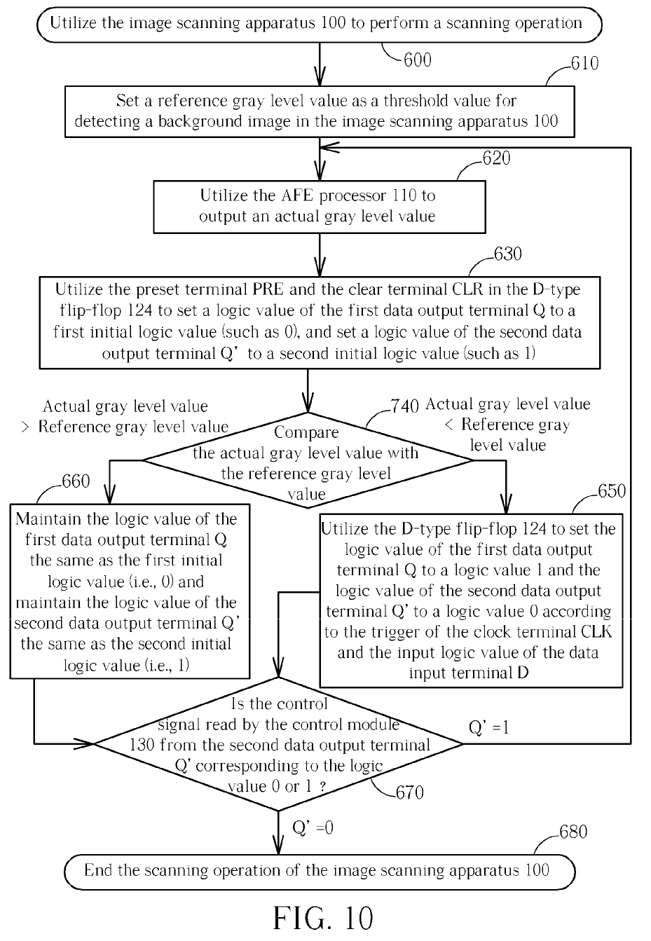

Please refer to FIG. 10. FIG. 10 is another flowchart showing the image scanning method of the second embodiment when black or dark scan background is used. The image scanning method includes the same steps as Steps 600 to 680 set forth above, except that Step 640 is replaced with a Step 740 described below:

Step 740: Utilize the comparing unit 122 to compare the actual gray level value with a reference gray level value to generate a comparing result. When the actual gray level value is lower than the reference gray level value, utilize the corresponding comparing result to trigger the clock terminal CLK of the D-type flip-flop, and then go to Step 650; when the actual gray level value is higher than the reference gray level value, go to Step 660.

The steps of the methods above need not be in the exact sequence as shown and need not be continuous.

Briefly summarized, the image scanning apparatus and the image scanning method disclosed by the present invention does not need any sensors, and can still detect the size of the scan target during the scanning process without being limited by the number of sensors and other factors, while the conventional image acquiring method and the related image acquiring apparatus cost a lot. The image acquiring apparatus and the image acquiring method disclosed by the present invention can perform the scanning operation efficiently without using a CPU having higher capability and a faster direct memory access (DMA) controller, and no data missing conditions will occur.

Those skilled in the art will readily observe that numerous modifications and alterations of the device and method may be made while retaining the teachings of the invention.

What is claimed is:

1. An image scanning apparatus having scan background, comprising:
an analog front end (AFE) processor, for outputting an actual gray level value corresponding to a gray level value of a scan image of a scan target and the scan background;
a logic circuit module, coupled to the AFE processor, for comparing the actual gray level value with a reference gray level value to output a control signal; and
a control module, coupled to the logic circuit module, for determining whether to stop a scanning operation according to the control signal.

2. The image scanning apparatus of claim 1, wherein when the actual gray level value is lower than the reference gray level value, the control module determines to continue the scanning operation according to the control signal.

3. The image scanning apparatus of claim 1, wherein when the actual gray level value is higher than the reference gray level value, the control module determines to continue the scanning operation according to the control signal.

4. The image scanning apparatus of claim 1, wherein the logic circuit module further comprises:
a comparing unit, for comparing the actual gray level value with the reference gray level value to generate a comparing result; and
a flip-flop, comprising a clock terminal, a data input terminal, and a data output terminal, wherein the clock terminal is coupled to the comparing unit to receive the comparing result; the data output terminal is coupled to the control module to output the control signal; and the flip-flop sets a logic value for the data output terminal according to a trigger of the clock terminal and an input logic value of the data input terminal.

5. The image scanning apparatus of claim 4, wherein the control module is constantly polling the data output terminal to read the control signal at a predetermined time interval.

6. The image scanning apparatus of claim 4, wherein the flip-flop further comprises a control terminal, for setting the logic value of the data output terminal to an initial logic value; when the actual gray level value is lower than the reference gray level value, the corresponding comparing result triggers the clock terminal of the flip-flop, wherein the flip-flop sets the logic value of the data output terminal to a specific logic value according to the trigger of the clock terminal and the input logic value of the data input terminal.

7. The image scanning apparatus of claim 6, wherein when the control signal read by the control module corresponds to the specific logic value, the control module continues the scanning operation and controls the control terminal to reset the logic value of the data output terminal to the initial logic value; and when the control signal read by the control module corresponds to the initial logic value, the control module stops the scanning operation.

8. The image scanning apparatus of claim 6, wherein when the control signal read by the control module corresponds to the specific logic value, the control module stops the scanning operation; and when the control signal read by the control module corresponds to the initial logic value, the control module continues the scanning operation.

9. The image scanning apparatus of claim 4, wherein the flip-flop further comprises a control terminal, for setting the logic value of the data output terminal to an initial logic value; when the actual gray level value is higher than the reference gray level value, the corresponding comparing result triggers the clock terminal of the flip-flop, wherein the flip-flop sets the logic value of the data output terminal to a specific logic value according to the trigger of the clock terminal and the input logic value of the data input terminal.

10. The image scanning apparatus of claim 9, wherein when the control signal read by the control module corresponds to the specific logic value, the control module continues the scanning operation and control the control terminal to reset the logic value of the data output terminal to the initial logic value; and when the control signal read by the control module from the data output terminal corresponds to the initial logic value, the control module stops the scanning operation.

11. The image scanning apparatus of claim 9, wherein when the control signal read by the control module corresponds to the specific logic value, the control module stops the scanning operation; and when the control signal read by the control module corresponds to the initial logic value, the control module continues the scanning operation.

12. The image scanning apparatus of claim 1, wherein the reference gray level value is set dependent on a color of the scan background.

13. An image scanning method, comprising the steps of:
setting a reference gray level value;
outputting an actual gray level value corresponding to a gray level value of a scan image of a scan target and scan background;
comparing the actual gray level value with the reference gray level value to output a control signal; and
determining whether to stop a scanning operation according to the control signal.

14. The image scanning method of claim 13, further comprising the step of:
stopping the scanning operation according to the control signal indicating that the actual gray level value is higher than the reference gray level value.

15. The image scanning method of claim 13, further comprising the step of:
stopping the scanning operation according to the control signal indicating that the actual gray level value is lower than the reference gray level value.

16. The image scanning method of claim 13, further comprising the step of:
executing a polling operation at a predetermined time interval to check the control signal.

17. The image scanning method of claim 13, wherein the step of setting the reference gray level value comprises the step of:
setting the reference gray level value dependent on a color of the scan background.
